(19) United States
(12) Patent Application Publication
(10) Pub. No.: US 2020/0219018 A1
(43) Pub. Date: Jul. 9, 2020

(54) ESTIMATING APPARATUS

(71) Applicant: Toyota Jidosha Kabushiki Kaisha, Toyota-shi Aichi-ken (JP)

(72) Inventor: Tatsuya Sugano, Susono-shi (JP)

(73) Assignee: Toyota Jidosha Kabushiki Kaisha, Toyota-shi Aichi-ken (JP)

(21) Appl. No.: 16/733,623

(22) Filed: Jan. 3, 2020

(30) Foreign Application Priority Data
Jan. 9, 2019 (JP) 2019-001696

(51) Int. Cl. G06Q 10/02; G06N 5/04

(52) U.S. Cl. CPC G06Q 10/02; G06Q 2240/00; G06N 5/04

(57) ABSTRACT

An estimating apparatus is provided with: a first acquirer configured to obtain first information, which indicates an entrance reservation time at which a user enters a vehicle in a parking lot; a second acquirer configured to obtain second information, which is different from the first information and which includes at least one of information about the user and information about the parking lot; an estimator configured to estimate an approximate exit time, which is a criterion of a scheduled exit time at which the user exits the vehicle from the parking lot, on the basis of the first information and the second information; and an output device configured to output the approximate exit time to a terminal that can be accessed by the user if the user is required to input the scheduled exit time.

### CROSS-REFERENCE TO RELATED APPLICATIONS

This application is based upon and claims the benefit of priority of the prior Japanese Patent Application No. 2019-001696, filed on Jan. 9, 2019, the entire contents of which are incorporated herein by reference.

### BACKGROUND

### 1. Technical Field

Embodiments of the present disclosure relate to an estimating apparatus configured to estimate an approximate exit time of a vehicle in a parking lot.

### 2. Description of the Related Art

In a parking lot that allows a parking reservation, an input of a scheduled exit time may be required at the time of reservation for the parking lot. For example, Japanese Patent Application Laid Open No. 2008-003975 (Patent Literature 1) discloses that users of a parking lot input a scheduled parking time when entering.

However, there are also some users who are not sure about the scheduled exit time at the time point of reservation for the parking lot. For such users, even if they are required to input the scheduled exit time at the time of reservation, it is hard to instantly complete the input. For example, the users are required to consider a parking time in view of a usage time of a facility the users will visit (i.e., a facility corresponding to the parking lot) or the like. As described above, the burden of the users may increase when the users are required to input the scheduled exit time in advance, which is technically problematic.

### SUMMARY

In view of the aforementioned problem, it is therefore an object of embodiments of the present disclosure to provide an estimating apparatus that can reduce the burden of users of a parking lot when the users input the scheduled exit time.

An aspect of an estimating apparatus according to the present disclosure is an estimating apparatus configured to assist a user who desires parking in making a parking reservation in a parking lot that allows the parking reservation, the estimating apparatus provided with: a first acquirer configured to obtain first information, which indicates an entrance reservation time at which the user enters a vehicle in the parking lot; a second acquirer configured to obtain second information, which is different from the first information and which includes at least one of information about the user and information about the parking lot; an estimator configured to estimate an approximate exit time, which is a criterion of a scheduled exit time at which the user exits the vehicle from the parking lot, on the basis of the first information and the second information; and an output device configured to output the approximate exit time to a terminal that can be accessed by the user if the user is required to input the scheduled exit time.

### BRIEF DESCRIPTION OF THE DRAWINGS

FIG. 1 is a block diagram illustrating a configuration of an estimating apparatus according to an embodiment;

FIG. 2 is a flowchart illustrating a flow of operations of the estimating apparatus according to the embodiment;

FIG. 3 is a graph illustrating an example of a method of estimating an approximate usage time from a parking time distribution of past users;

FIG. 4 is a graph illustrating an example of a method of estimating an approximate exit time from the number of exit reservations by current users;

FIG. 5 is a graph illustrating an example of a method of estimating the approximate exit time from a time point of a change in a parking fee; and

FIG. 6 is a schematic diagram illustrating an example of a display aspect of the approximate exit time on a user terminal.

### DETAILED DESCRIPTION

Hereinafter, an estimating apparatus according to an embodiment of the present disclosure will be explained with reference to the drawings.

<Configuration of Apparatus>

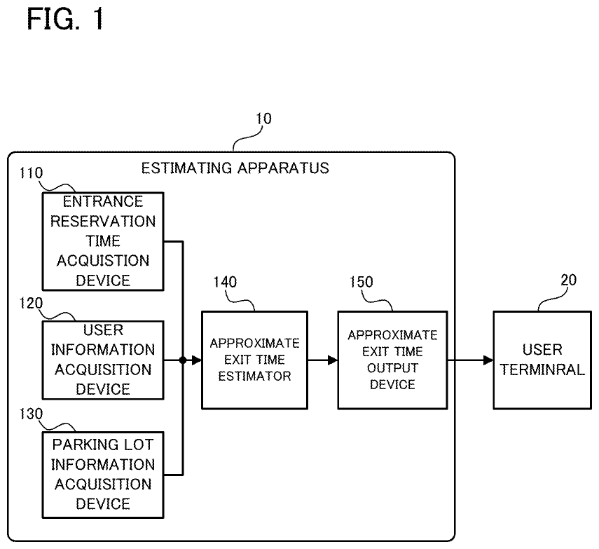

Firstly, a configuration of the estimating apparatus according to the embodiment will be explained with reference to FIG. 1. FIG. 1 is a block diagram illustrating the configuration of the estimating apparatus according to the embodiment.

In FIG. 1, an estimating apparatus 10 according to the embodiment may be an apparatus to be applied to a reservable parking lot system, which is typically an automated valet parking system, and is configured, for example, as a part of a parking lot administrative server (which may particularly have a function of managing a parking reservation). The estimating apparatus 10 is configured as an apparatus that can output an estimated approximate exit time, to a user who makes a reservation for a parking lot. The estimating apparatus 10 is provided with an entrance reservation time acquisition device 110, a user information acquisition device 120, a parking lot information acquisition device 130, an approximate exit time estimator 140, and an approximate exit time output device 150.

The entrance reservation time acquisition device 110 is configured to obtain an entrance reservation time inputted by the user, for example, from a user terminal 20 or the like. The “entrance reservation time” herein may indicate a time at which the user intends to enter a vehicle in the parking lot, and the user may be required to input the entrance reservation time when making a reservation for the parking lot. The entrance reservation time obtained by the entrance reservation time acquisition device 110 may be outputted to the approximate exit time estimator 140. The entrance reservation time acquisition device 110 is a specific example of the “first acquirer” in Supplementary Notes described later.

The user information acquisition device 120 is configured to obtain information about the user (hereinafter referred to as “user information” as occasion demands), for example, from the user terminal 20 or the like. The “user information” herein may be different from the entrance reservation time, out of information about the use of the parking lot by the user, and may include, for example, information set by the user in advance in using the parking lot, information about a past usage history, or the like. The user information obtained by the user information acquisition device 120 may be outputted to the approximate exit time estimator 140. The user information acquisition device 120 is a specific example of the “second acquirer” in Supplementary Notes described later. Moreover, the user information is a specific example of the “second information” in Supplementary Notes described later.

The parking lot information acquisition device 130 is configured to obtain information about the parking lot, for example, from a not-illustrated database of the parking lot system or the like. The “parking lot information” herein may be various information used in managing the parking lot, and may include, for example, information indicating a situation of current utilization of the parking lot (which is specifically current utilization number, a scheduled exit time of each vehicle, etc.), information indicating a situation of past utilization of the parking lot (which is specifically, a distribution of users for each time zone, etc.), information about a parking lot usage fee, or information about a facility corresponding to the parking lot, or the like. The parking lot information obtained by the parking lot information acquisition device 130 may be outputted to the approximate exit time estimator 140. The parking lot information acquisition device 130 is a specific example of the “second acquirer” in Supplementary Notes described later, as in the user information acquisition device 120. The parking lot information is a specific example of the “second information” in Supplementary Notes described later.

The approximate exit time estimator 140 is configured to estimate or arithmetically operate an approximate exit time, which is a criterion of the scheduled exit time of the user, on the basis of the entrance reservation time obtained by the entrance reservation time acquisition device 110, the user information obtained by the user information acquisition device 120, and the parking lot information obtained by the parking lot information acquisition device 130. A specific method of estimating the approximate exit time, performed by the approximate exit time estimator 140, will be detailed later. The approximate exit time estimated by the approximate exit time estimator 140 may be outputted to the approximate exit time output device 150. The approximate exit time estimator 140 is a specific example of the “estimator” in Supplementary Notes described later.

The approximate exit time output device 150 is configured to output the approximate exit time estimated by the approximate exit time estimator 140, to the user terminal 20. In other words, the approximate exit time output device 150 is configured to display the approximate exit time estimated by the approximate exit time estimator 140, on a terminal that can be accessed by the user. The approximate exit time output device 150 is a specific example of the “outputting device” in Supplementary Notes described later. Moreover, the user terminal 20 is a specific example of the “terminal that can be accessed by the user” in Supplementary Notes described later.

<Explanation of Operation>

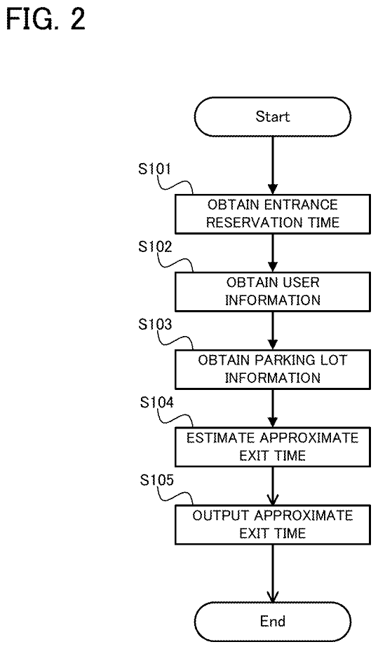

Next, a flow of operations of the estimating apparatus 10 according to the embodiment will be explained with reference to FIG. 2. FIG. 2 is a flowchart illustrating the flow of the operations of the estimating apparatus according to the embodiment. A series of operations explained below is performed when the user reserves the parking lot.

As illustrated in FIG. 2, in operation of the estimating apparatus 10 according to the embodiment, the entrance reservation time acquisition device 110 firstly obtains the entrance reservation time (step S101). The user information acquisition device 120 then obtains the user information (step S102). Then, the parking lot information acquisition device 130 obtains the parking lot information (step S103). The aforementioned steps S102 and S103 for obtaining the respective information may be performed one after another, or may be performed at the same time in parallel.

The approximate exit time estimator 140 then estimates the approximate exit time, on the basis of the entrance reservation time, the user information, and the parking lot information (step S104). Then, the approximate exit time output device 150 outputs the approximate exit time estimated by the approximate exit time estimator 140, to the user terminal 20 (i.e., a terminal on which the user performs a reservation operation) (step S105). By this, the outputted approximate exit time is displayed on the user terminal 20.

<Method of Estimating Approximate Exit Time>

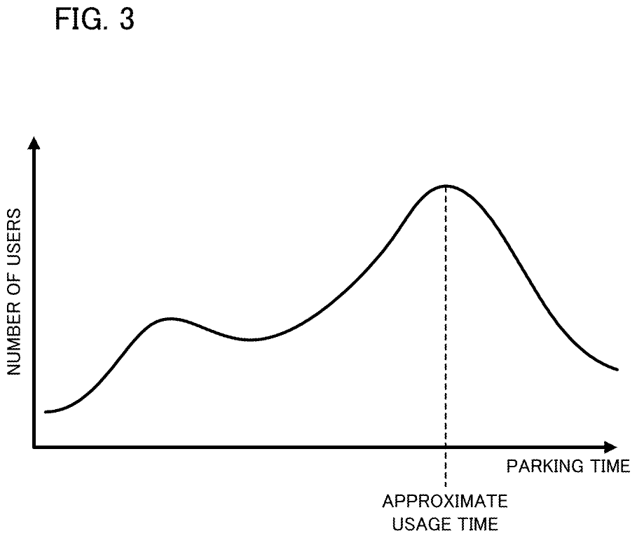

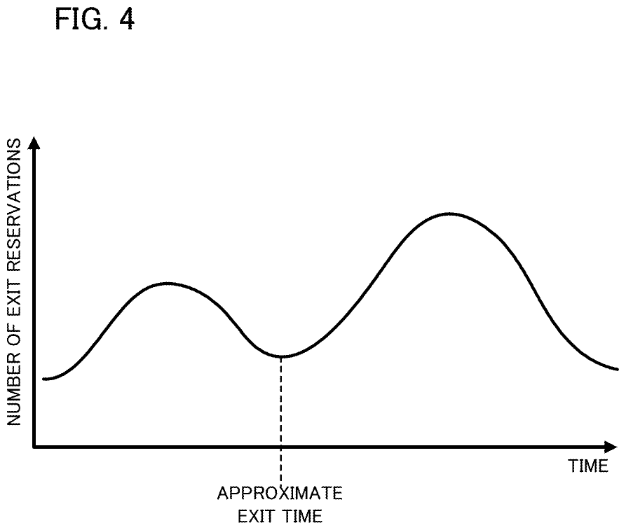

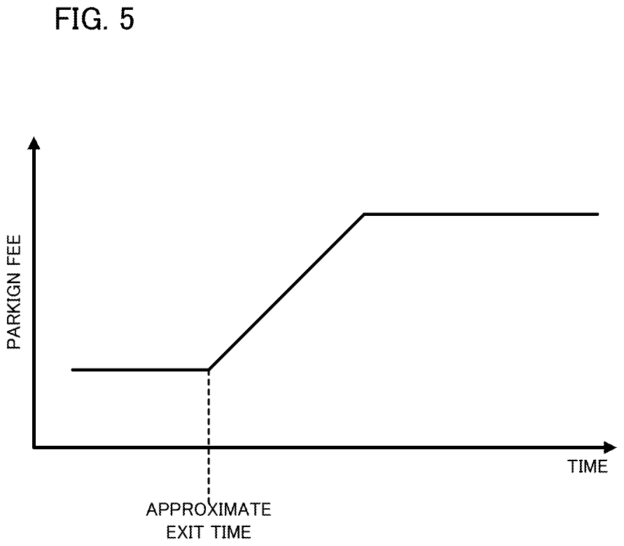

Next, a specific method of estimating the approximate exit time (i.e., the details of the step S104 in FIG. 2) will be explained with reference to FIG. 3 to FIG. 5. FIG. 3 is a graph illustrating an example of a method of estimating an approximate usage time from a parking time distribution of past users. FIG. 4 is a graph illustrating an example of a method of estimating the approximate exit time from the number of exit reservations by current users. FIG. 5 is a graph illustrating an example of a method of estimating the approximate exit time from a time point of a change in a parking fee.

In FIG. 3, the approximate exit time may be obtained on the basis of the parking time distribution of past parking lot users, which is included in the parking lot information obtained by the parking lot information acquisition device 130. Specifically, a representative parking time at which there are the largest number of users may be obtained as the approximate usage time from a distribution of users with respect to the parking time, and a time obtained by adding the approximate usage time to the entrance reservation time may be outputted as the approximate exit time. In this case, it is possible to estimate the approximate exit time that takes into account the behavior of other users.

Alternatively, the approximate exit time may be also estimated on the basis of past user history information, which is included in the user information obtained by the user information acquisition device 120. Specifically, the approximate exit time may be estimated on the basis of an average value or a previous value of the parking time when the user uses the same parking lot, or the like. In this case, it is possible to estimate the approximate exit time that takes into account the user's tendency.

In FIG. 4, the approximate exit time may be also estimated on the basis of scheduled exit times of current users, which is included in the parking lot information obtained by the parking lot information acquisition device 130. Specifically, a time at which there are the smallest number of exit reservations may be estimated as the approximate exit time, from a time distribution of the number of exit reservations. In this case, it is possible to estimate the approximate exit time that allows the avoidance of congestion caused by other leaving vehicles.

Alternatively, the approximate exit time may be also estimated on the basis of scheduled entrance times of other users who have reservations for the parking lot. Specifically, a time at which there are the smallest number of entrance reservations may be estimated as the approximate exit time, from a time distribution of the number of entrance reservations. In this case, it is possible to estimate the approximate exit time that allows the avoidance of congestion caused by other entering vehicles.

Alternatively, the approximate exit time may be also estimated on the basis of the number of other vehicles that enter a route when the user's vehicle exits, which is included in the parking lot information obtained by the parking lot information acquisition device 130. Specifically, information about a route length when the user exits the vehicle, information about the number of routes, and information about the number of merging vehicles may be obtained, and a time at which the congestion most hardly occurs may be estimated as the approximate exit time. At this time, the time distribution of the number of exit reservations illustrated in FIG. 4 may be used as the information about the number of merging vehicles. The time distribution of the number of entrance reservations may be also used as the information about the number of merging vehicles. As described above, in view of the number of vehicles that enter a driving route of the vehicle, it is possible to estimate the approximate exit time that allows the congestion to be avoided more certainly, in comparison with the case in FIG. 4.

As illustrated in FIG. 5, the approximate exit time may be also estimated on the basis of the time point of the change in the parking fee, which is included in the parking lot information obtained by the parking lot information acquisition device 130. Specifically, a time immediately before the parking fee changes may be estimated as the approximate exit time. In this case, it is possible to estimate the approximate exit time that allows an inexpensive parking fee.

Alternatively, the approximate exit time may be also estimated on the basis of the information about a facility corresponding to the parking lot (i.e., a facility the user who has parked will visit), which is included in the parking lot information obtained by the parking lot information acquisition device 130. Specifically, the approximate exit time may be estimated from the closing time of a commercial facility, the last flight at an airport, a final checkout time of a hotel, the closing time of an amusement facility, or the like. In this case, it is possible to estimate the approximate exit time that allows the user to stay and relax at a facility (or that allows the user to stay until the last minute of an available time).

<Technical Effect>

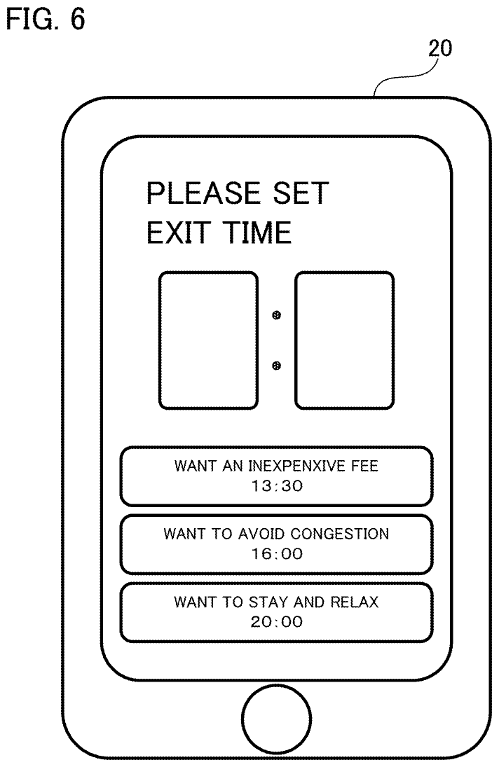

Next, a technical effect obtained by the estimating apparatus 10 according to the embodiment will be specifically explained with reference to FIG. 6. FIG. 6 is a schematic diagram illustrating an example of a display aspect of the approximate exit time on the user terminal.

As illustrated in FIG. 6, the approximate exit time outputted from the estimating apparatus 10 may be displayed when the input of the approximate exit time is required on the user terminal 20 (e.g., a smartphone, etc.). In an example in FIG. 6, together with a message of “PLEASE SET EXIT TIME”, which requires the input of the scheduled exit time, there are displayed an approximate exit time (13:30) in the case of wanting an inexpensive fee, an approximate exit time (16:00) in the case of wanting to avoid congestion, and an approximate exit time (20:00) in the case of wanting to stay and relax.

Here, the approximate exit time in the case of wanting an inexpensive fee may be an approximate exit time estimated, for example, on the basis of the time point of the change in the parking fee described above. The approximate exit time in the case of wanting to avoid the congestion may be an approximate exit time estimated, for example, on the basis of the scheduled exit times of current users, the scheduled entrance times of other users who have reservations for the parking lot, or the number of other vehicles that enter a route when the user's vehicle exits. The approximate exit time in the case of wanting to stay and relax may be an approximate exit time estimated, for example, on the basis of the information about a facility corresponding to the parking lot. In other words, if a plurality of approximate exit times are respectively estimated on the basis of a plurality of different types of information (or particularly, a plurality of types of information included in the second information), the plurality of approximate exit times may be displayed in parallel. The display aspect herein is merely an example, and one or two approximate exit times, or four or more approximate exit times may be displayed. Moreover, the approximate exit time(s) displayed may change, for example, on the basis of the user information obtained by the user information acquisition device 120. For example, the display order of the approximate exit times may change depending on user settings, or a recommended approximate exit time may be displayed.

In the reservable parking lot (or particularly, an automated valet parking lot), the input of the scheduled exit time may be required at the time of reservation to enter. It is, however, hard to instantly input an accurate scheduled exit time at the time point of reservation, and the user may be required to consider a usage time of the parking lot. If the approximate exit time is not displayed at all, the burden of the user may significantly increase.

In the embodiment, however, as explained above, the approximate exit time estimated by the estimating apparatus 10 may be displayed on the user terminal 20. Thus, the user can set (or input) the scheduled exit time with reference to the displayed approximate exit time. Moreover, the plurality of approximate exit times are displayed for each purpose, by which it is possible to set the scheduled exit time suitable for the user.

As explained above, according to the estimating apparatus 10 in the embodiment, it is possible to reduce the burden of the user inputting the scheduled exit time by estimating and outputting the approximate exit time(s).

<Supplementary Notes>

Various aspects of embodiments of the present disclosure derived from the embodiment explained above will be explained hereinafter.

(Supplementary Note 1)

An estimating apparatus described in Supplementary Note 1 is an estimating apparatus configured to assist a user who desires parking in making a parking reservation in a parking lot that allows the parking reservation, the estimating apparatus provided with: a first acquirer configured to obtain first information, which indicates an entrance reservation time at which the user enters a vehicle in the parking lot; a second acquirer configured to obtain second information, which is different from the first information and which includes at least one of information about the user and information about the parking lot; an estimator configured to estimate an approximate exit time, which is a criterion of a scheduled exit time at which the user exits the vehicle from the parking lot, on the basis of the first information and the second information; and an output device configured to output the approximate exit time to a terminal that can be accessed by the user if the user is required to input the scheduled exit time.

According to the estimating apparatus described in Supplementary Note 1, the approximate exit time, which is estimated on the basis of the first information and the second information, may be outputted to the terminal that can be accessed by the user (in other words, the approximate exit time may be displayed for the user). It is thus possible to reduce the burden of the user inputting the scheduled exit time (e.g., the burden of considering the scheduled exit time in view of various information).

(Supplementary Note 2)

In an estimating apparatus described in Supplementary Note 2, the estimator is configured to estimate the approximate exit time on the basis of a parking time distribution of past users in the parking lot, which is included in the second information.

According to the estimating apparatus described in Supplementary Note 2, it is possible to estimate the approximate exit time suitable for the exit (e.g., an approximate exit time corresponding to a representative parking time at which there are the largest number of users), by using information about the parking time distribution of past users.

(Supplementary Note 3)

In an estimating apparatus described in Supplementary Note 3, the estimator is configured to estimate the approximate exit time on the basis of a past parking time of the user in the parking lot, which is included in the second information.

According to the estimating apparatus described in Supplementary Note 3, it is possible to estimate the approximate exit time suitable for the exit (e.g., an approximate exit time corresponding to a parking time in the previous use), by using information about the past parking time of the user.

(Supplementary Note 4)

In an estimating apparatus described in Supplementary Note 4, the estimator is configured to estimate the approximate exit time, on the basis of a number of vehicles having a reservation to enter the parking lot, or a number of vehicles having a reservation to exit from the parking lot, which is included in the second information.

According to the estimating apparatus described in Supplementary Note 4, it is possible to estimate the approximate exit time suitable for the exit (e.g., an approximate exit time at which there is no congestion caused by entering vehicles and leaving vehicles), by using information about the number of vehicles having a reservation to enter, or about the number of vehicles having a reservation to exit.

(Supplementary Note 5)

In an estimating apparatus described in Supplementary Note 5, the estimator is configured to estimate the approximate exit time, on the basis of a number of other vehicles that enter an exit route of the vehicle of the user when the user exits the vehicle, which is included in the second information.

According to the estimating apparatus described in Supplementary Note 5, it is possible to estimate the approximate exit time suitable for the exit (e.g., an approximate exit time at which there are the smallest number of other merging vehicles and at which a time required for the exit is short), by using information about the number of other vehicles that enter the exit route of the vehicle of the user.

(Supplementary Note 6)

In an estimating apparatus described in Supplementary Note 6, the estimator is configured to estimate the approximate exit time on the basis of a time point of a change in a parking fee of the parking lot, which is included in the second information.

According to the estimating apparatus described in Supplementary Note 6, it is possible to estimate the approximate exit time suitable for the exit (e.g., an approximate exit time corresponding to a time immediately before the parking fee increases), by using information about the time point of the change in the parking fee.

(Supplementary Note 7)

In an estimating apparatus described in Supplementary Note 7, the estimator is configured to estimate the approximate exit time on the basis of information about a facility associated with the parking lot, which is included in the second information.

According to the estimating apparatus described in Supplementary Note 7, it is possible to estimate the approximate exit time suitable for the exit (e.g., an approximate exit time corresponding to the closing time of a facility), by using information about the facility associated with the parking lot.

The present disclosure may be embodied in other specific forms without departing from the spirit or essential characteristics thereof. The present embodiments and examples are therefore to be considered in all respects as illustrative and not restrictive, the scope of the disclosure being indicated by the appended claims rather than by the foregoing description and all changes which come in the meaning and range of equivalency of the claims are therefore intended to be embraced therein.

What is claimed is:

1. An estimating apparatus configured to assist a user who desires parking in making a parking reservation in a parking lot that allows the parking reservation, said estimating apparatus comprising:
a first acquirer configured to obtain first information, which indicates an entrance reservation time at which the user enters a vehicle in the parking lot;
a second acquirer configured to obtain second information, which is different from the first information and which includes at least one of information about the user and information about the parking lot;
an estimator configured to estimate an approximate exit time, which is a criterion of a scheduled exit time at which the user exits the vehicle from the parking lot, on the basis of the first information and the second information; and
an output device configured to output the approximate exit time to a terminal that can be accessed by the user if the user is required to input the scheduled exit time.

2. The estimating apparatus according to claim 1, wherein said estimator is configured to estimate the approximate exit time on the basis of a parking time distribution of past users in the parking lot, which is included in the second information.

3. The estimating apparatus according to claim 1, wherein said estimator is configured to estimate the approximate exit time on the basis of a past parking time of the user in the parking lot, which is included in the second information.

4. The estimating apparatus according to claim 1, wherein said estimator is configured to estimate the approximate exit time, on the basis of a number of vehicles having a reservation to enter the parking lot, or a number of vehicles having a reservation to exit from the parking lot, which is included in the second information.

5. The estimating apparatus according to claim 1, wherein said estimator is configured to estimate the approximate exit time, on the basis of a number of other vehicles that enter an exit route of the vehicle of the user when the user exits the vehicle, which is included in the second information.

6. The estimating apparatus according to claim 1, wherein said estimator is configured to estimate the approximate exit time on the basis of a time point of a change in a parking fee of the parking lot, which is included in the second information.

7. The estimating apparatus according to claim 1, wherein said estimator is configured to estimate the approximate exit time on the basis of information about a facility associated with the parking lot, which is included in the second information.
